(19) United States
(12) Patent Application Publication
(10) Pub. No.: US 2010/0289944 A1
(43) Pub. Date: Nov. 18, 2010

(54) Frame Rate Up-Conversion Based Dynamic Backlight Control System and Method

(76) Inventors: Shing-Chia Chen, Tainan (TW); Ling-Hsiu Huang, Sinshih Township (TW)

Correspondence Address: STOUT, UXA, BUYAN & MULLINS LLP, 4 VENTURE, SUITE 300, IRVINE, CA, 92618, US

(21) Appl. No.: 12/464,802

(22) Filed: May 12, 2009

(51) Int. Cl. H04N 7/01; H04N 5/57

(52) U.S. Cl. 348/441; 348/687; 348/E07.003; 348/E05.119

(57) ABSTRACT

A frame rate up-conversion (FRUC) based dynamic backlight control (DBLC) system and method are disclosed. A frame rate up-conversion (FRUC) unit increases frame rate by adding at least one image frame in a video display, and a dynamic backlight control (DBLC) unit adjusts backlight luminance in the video display. The DBLC unit operates at an original frame rate, and adjusts the backlight luminance for the added image frame according to statistical information about the added image frame derived from the FRUC unit.

### BACKGROUND OF THE INVENTION

1. Field of the Invention

The present invention generally relates to dynamic backlight control (DBLC), and more particularly to a DBLC system integrated with frame rate up-conversion (FRUC).

2. Description of the Prior Art

Backlight is used to illuminate a flat panel display, such as a liquid crystal display (LCD), from the back or side of the flat panel display. Light sources of the backlight may be cold cathode fluorescent lamp (CCFL), light-emitting diode (LED), or other types of light sources.

A constant backlight is one that outputs even and constant light no matter how the image data or the ambient light has been changed. The constant backlight has a disadvantage, among others, of light leakage of the display caused by the backlight when the pixels of the display are in dark level (“0”), which results in low dynamic contrast.

In order to alleviate this disadvantage, a dynamic backlight (DBL) approach has been proposed in the past to dynamically or adaptively adjust (overall or respective portions of) the backlight luminance in accordance with image data distribution or the ambient light. For example, when the image is bright the backlight outputs high luminance, and when the image is dark the backlight is dimmed, thereby reducing light leakage. Accordingly, the dynamic backlight approach has a higher dynamic contrast than the constant backlight. Further, the dynamic backlight approach reduces power consumption as compared to the constant backlight.

Frame rate up-conversion (FRUC) is another technique commonly used in flat panel displays, such as liquid crystal displays (LCDs). Frame rate up-conversion (FRUC) may be used to increase the frame rate in a video display, particularly in a video application restricted with low bandwidth, in order to improve motion blur and flicker problems. However, the frame rate up-conversion is a time-consuming operation. Accordingly, integrating a dynamic backlight control (DBLC) system with frame rate up-conversion (FRUC) can be complicated in design, thus introducing huge budgetary pressures on timing and resources.

For the reason that there are difficulties with integrating frame rate up-conversion (FRUC) with dynamic backlight control (DBLC) systems using conventional techniques, a need has arisen to propose a novel FRUC based DBLC system, which may alleviate timing and resource pressures.

### SUMMARY OF THE INVENTION

In view of the foregoing, it is an object of the present invention to provide a frame rate up-conversion (FRUC) based dynamic backlight control (DBLC) system having both simple architecture and a flexible timing design.

According to one embodiment of the present invention, a frame rate up-conversion (FRUC) unit increases frame rate by interpolating at least one image frame in a video display, and a dynamic backlight control (DBLC) unit adjusts backlight luminance in the video display. The DBLC unit operates at an original frame rate, and adjusts the backlight luminance for the interpolated image frame according to statistical information (such as average luminance) derived from the FRUC unit on the interpolated image frame.

### BRIEF DESCRIPTION OF THE DRAWINGS

FIG. 1 is a block diagram illustrating data flow of a FRUC based DBLC system (without frame buffer) according to one embodiment of the present invention; and

FIG. 2 is a block diagram illustrating data flow of a FRUC based DBLC system (with frame buffer) according to another embodiment of the present invention.

### DETAILED DESCRIPTION OF THE INVENTION

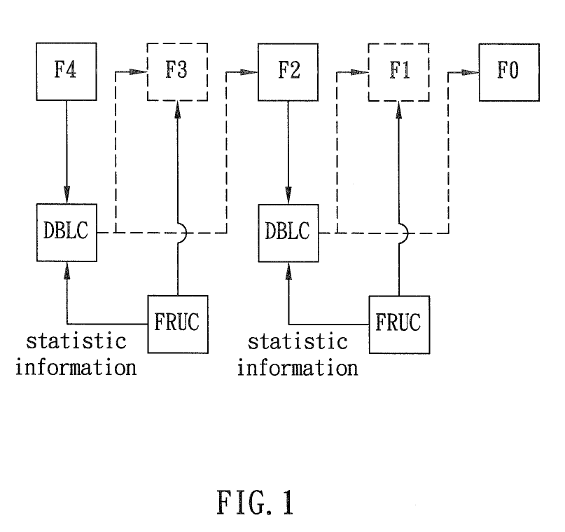

Referring more particularly to the drawings, FIG. 1 is a block diagram illustrating data flow of a frame rate up-conversion (FRUC) based dynamic backlight control (DBLC) system according to one embodiment of the present invention. In the figure, the exemplary frames F4, F2 and F0 stand for original frames, and the exemplary frames F3 and F1 stand for converted frames that are respectively converted by the frame rate up-conversion (FRUC) unit. As a result, the frame rate of a video display may be increased from, for example but not limited to, 60 Hz to 120 Hz. The FRUC may be performed, for example, by interpolating an image frame between two original frames. For example, the frame F3 in the figure is interpolated between the neighboring original (or reference) frames F4 and F2, and the frame F1 is interpolated between the neighboring original frames F2 and F0. The detailed structure and operation of the FRUC are omitted in this specification; reference may be made to, for example, US Patent Publication Nos. 2008/0310508, 2008/0284908 and 2008/0304568, the disclosures of which are hereby incorporated by reference.

In the embodiment, the dynamic backlight control (DBLC) unit respectively adjusts (overall or respective portions of) the backlight luminance in accordance with image data distribution. For example, when the image is bright the backlight outputs high luminance, and when the image is dark the backlight is dimmed. In additional and/or alternative embodiments, the DBLC unit may dynamically adjust (overall or respective portions of) the backlight luminance in accordance with ambient light. In any of these cases, the DBLC unit may be (e.g., implement) global DBLC by which the amount of backlight luminance adjustment is the same throughout the entire frame. The DBLC unit may, additionally and/or instead, be (e.g., implement) local DBLC by which the amount of backlight luminance adjustment is determined locally with respect to local data distribution.

In the embodiment of FIG. 1, the DBLC unit operates at the original frame rate (i.e., 60 Hz in the example), instead of the up conversion rate (i.e., 120 Hz in the example). As the DBLC operates at the non-up frame rate in the embodiment, more timing bandwidth may give way to the time-consuming FRUC. Furthermore, during performing of the frame rate up-conversion (for example, interpolating the frame F3 between the original frame F4 and F2), the FRUC unit further transfers statistical information, such as the average luminance of the frame to be interpolated (for example, frame F3), to the DBLC unit. The DBLC accordingly uses this statistical information to adjust the backlight luminance (for example, providing backlight to the frames F3 and F2 in accordance with the FRUC-derived statistical information about the frame F3). As the DBLC unit need not derive the statistical information about the interpolated frame, more timing bandwidth may further give way to the time-consuming FRUC.

Generally speaking, the FRUC unit performs frame rate up-conversion by interpolating a frame according to at least one original frame. For example, the FRUC unit interpolates the frame F3 between the original (or reference) frames F4 and F2. On the other hand, the DBLC unit receives statistical information about the interpolated frame derived from the FRUC unit. Based on the received statistical information, the DBLC unit then adjusts both the backlight luminance for the interpolated frame and the frame succeeding the interpolated frame. For example, the DBLC unit receives the average luminance information about the interpolated frame F3 from the FRUC unit, and then accordingly adjusts the backlight luminance for both the interpolated frame F3 and the succeeding frame F2. It is noted that the DBLC unit may operate at the original non-up frame rate (e.g., 60 Hz) instead of the converted frame rate (e.g., 120 Hz). It is also noted that the backlight luminance provided by the DBLC unit to the interpolated frame and the succeeding frame may not necessarily be the same. For example, the backlight luminance for the interpolated frame F3 may be different from that for the succeeding frame F2.

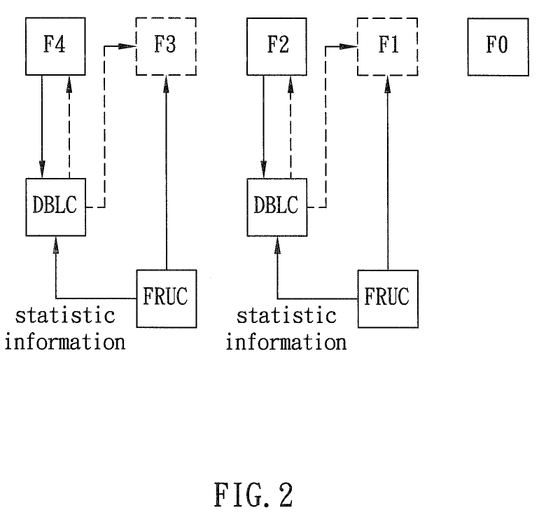

FIG. 2 shows a block diagram illustrating data flow of a FRUC based DBLC system according to another embodiment of the present invention. In contrast to the system illustrated in FIG. 1, the FRUC based DBLC system of FIG. 2 further uses a frame buffer for temporarily storing content of the original image frame. For example, assume that the frame F4 is the present image frame which is stored in the frame buffer. The DBLC unit determines the backlight luminance for the present frame based on the content of the buffered frame (e.g., the frame F4). Further, being similar to the system of FIG. 1, the DBLC unit also adjusts backlight luminance for the interpolated frame based on the statistical information provided by the FRUC unit. Compared to the system without using the frame buffer as illustrated in FIG. 1, the system with frame buffering as illustrated in FIG. 2 adjusts the backlight luminance for the present (original) frame and the subsequent interpolated frame, while the system without a frame buffer (FIG. 1) adjusts the backlight luminance for the interpolated frame and the next (original) frame.

According to the embodiments (FIG. 1 and FIG. 2) described above, the DBLC unit operates at the original frame rate, and uses statistical information derived from the FRUC unit to adjust backlight luminance, therefore giving more timing bandwidth to the time-consuming FRUC and alleviating timing and resource pressure.

Although specific embodiments have been illustrated and described, it will be appreciated by those skilled in the art that various modifications may be made without departing from the scope of the present invention, which is intended to be limited solely by the appended claims.

What is claimed is:

1. A frame rate up-conversion (FRUC) based dynamic backlight control (DBLC) system, comprising:
a frame rate up-conversion (FRUC) unit for increasing frame rate by adding at least one image frame in a video display; and
a dynamic backlight control (DBLC) unit for adjusting backlight luminance in the video display;
wherein the DBLC unit operates at an original frame rate, and
wherein the DBLC unit adjusts backlight luminance for the added image frame according to statistical information about the added image frame derived from the FRUC unit.

2. The system of claim 1, wherein the FRUC unit interpolates to generate the added image frame according to at least one original image frame.

3. The system of claim 2, wherein the FRUC unit interpolates the added image frame between two neighboring original image frames.

4. The system of claim 1, wherein the statistical information is average luminance of the added image frame.

5. The system of claim 1, wherein the DBLC unit adjusts the backlight luminance of the image frame succeeding the added image frame based on the statistical information about the added image frame.

6. The system of claim 1, further comprising a frame buffer for temporarily storing content of a present image frame.

7. The system of claim 6, wherein the DBLC unit adjusts the backlight luminance of the present image frame according to the stored image frame.

8. The system of claim 1, wherein the DBLC unit implements global DBLC by which an amount of backlight luminance adjustment is the same throughout the entire image frame.

9. The system of claim 1, wherein the DBLC unit implements local DBLC by which an amount of backlight luminance adjustment is determined locally with respect to local data distribution of the image frame.

10. A frame rate up-conversion (FRUC) based dynamic backlight control (DBLC) method, comprising:
up-converting a frame rate by adding at least one image frame in a video display; and
dynamically adjusting backlight luminance in the video display;
wherein the backlight luminance adjustment is operated at an original frame rate, and
wherein the backlight luminance adjustment for the added image frame is performed according to statistical information about the added image frame derived from the frame rate up-conversion.

11. The method of claim 10, wherein the added image frame is generated by interpolation according to at least one original image frame.

12. The method of claim 11, wherein the added image frame is generated by interpolation between two neighboring original image frames.

13. The method of claim 10, wherein the statistical information is average luminance of the added image frame.

14. The method of claim 10, wherein the backlight luminance adjustment of the image frame succeeding the added image frame is performed based on the statistical information about the added image frame.

15. The method of claim 10, further comprising a frame buffer for temporarily storing content of a present image frame.

16. The method of claim 15, wherein the backlight luminance adjustment of the present image frame is performed based on the stored image frame.

17. The method of claim 10, wherein an amount of the backlight luminance adjustment is the same throughout the entire image frame.

18. The method of claim 10, wherein an amount of the backlight luminance adjustment is determined locally with respect to a local data distribution of the image frame.
